(19) United States
(12) Patent Application Publication
(10) Pub. No.: US 2017/0103174 A1
(43) Pub. Date: Apr. 13, 2017

(54) DIAGNOSIS MODEL GENERATION SYSTEM AND METHOD

(71) Applicant: Samsung Electronics Co., Ltd., Suwon-si (KR)

(72) Inventors: Ha-Young KIM, Yongin-si (KR); Hye-Jin KAM, Seongnam-si (KR)

(73) Assignee: Samsung Electronics Co., Ltd., Suwon-si (KR)

(21) Appl. No.: 15/388,916

(22) Filed: Dec. 22, 2016

Related U.S. Application Data
(63) Continuation of application No. PCT/KR2014/005647, filed on Jun. 25, 2014.

(51) Int. Cl. G06F 19/00

(52) U.S. Cl. CPC G06F 19/345; G06F 19/3406; G06F 19/3437

(57) ABSTRACT

A system to generate a diagnosis model includes: a preprocessor configured to preprocess time-series data observed from a patient having a disease; a time-series analyzer configured to produce a data feature by applying an analysis model for a time-series variability analysis to the preprocessed time-series data; and a model generator configured to extract the produced data feature and to generate the diagnosis model based on the extracted produced data feature.

### CROSS-REFERENCE TO RELATED APPLICATIONS

This application is a continuation of International Application No. PCT/KR2014/005647 filed on Jun. 25, 2014, the entire disclosure of which is incorporated herein by reference for all purposes.

### BACKGROUND

1. Field

The following description relates to a system and method to generate a diagnosis model, and more particularly, to a system and method to generate a diagnosis model based on a time-series variability analysis of observational data.

2. Description of Related Art

In general, sensor-based monitoring techniques for monitoring health condition of a patient are known. These are techniques of monitoring a patient using sensors which analyze blood components of the patient, measure heartbeat data, or measure the amount of activity. For example, using various mobile sensor devices, such as a blood glucose monitoring device, a portable electrocardiogram (ECG) sensor, actigraphy sensor, etc., it is possible to acquire observational data from a patient. These sensor-based monitoring techniques make it possible to continuously monitor a subject for several days to several months without disrupting daily life of the subject.

As a result of monitoring, it is possible to obtain, for example, observational data of blood glucose levels of a diabetes patient (diabetic), observational data of atrial fibrillation of an arrhythmia patient, and observational values, such as the amount of activity, etc. of an attention deficit hyperactivity disorder (ADHD) patient, a dementia patient having Alzheimer's disease or so on, and a melancholiac. Together with various other clinical diagnosis results, the obtained observational values may be used for diagnosis or treatment of a disease. Furthermore, diagnosis models according to related art are known, which are generated using some feature values extracted from monitored observational data. However, the application range of such diagnosis models based on feature values is limited to only diseases which may be diagnosed from just simple changes in observational values. In other words, diagnosis models based on feature vales are difficult to be applied to diseases which are difficult to be diagnosed or predicted using simple changes in observational values, such as ADHD, depression, chronic disease, disease requiring a long-term treatment, and so on.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a system to generate a diagnosis model includes: a preprocessor configured to preprocess time-series data observed from a patient having a disease; a time-series analyzer configured to produce a data feature by applying an analysis model for a time-series variability analysis to the preprocessed time-series data; and a model generator configured to extract the produced data feature and to generate the diagnosis model based on the extracted produced data feature.

The system may further include a training processor configured to train the diagnosis model generated by the model generator using the time-series data before prior to the time-series data being preprocessed by the preprocessor.

The system may further include an analysis model selector configured to select the analysis model according to a feature of the disease.

The time-series analyzer may include a first time-series analyzer configured to produce the data feature by applying the analysis model for the time-series variability analysis to the preprocessed time-series data, and a second time-series analyzer configured to produce data feature information of the extracted produced data feature by conducting a time-series variability analysis on the extracted produced data feature. The model generator may be further configured to generate the diagnosis model based on the data feature information.

The model generator may include: a first model generator configured to extract the data feature produced by the first time-series analyzer; and a second model generator configured to extract the data feature information produced by the second time-series analyzer.

The preprocessor may be further configured to: select a part of the time-series data; generate any one value or any combination of two or more values among a sum, an average, a median, a maximum, a minimum, a variance, a standard deviation, a number of outliers, a value equal to or greater than a reference value, and a value equal to or less than the reference value of the time-series data at predetermined time points; or extract a part or a particular value of the time-series data at predetermined time periods.

The data feature may include a trend, a cycle, seasonality, and volatility.

The analysis model may include any one or any combination of two or more of a time varying coefficient model, an autoregressive conditional heteroskedasticity (ARCH) model, a generalized ARCH (GARCH) model, a stochastic volatility model, and a model combined with an autoregressive integrated moving average (ARIMA) model.

The time-series data may include data obtained from an actigraphy sensor worn by the patient.

In another general aspect, a method to generate a diagnosis model includes: preprocessing time-series data observed from a patient having a disease; producing a data feature by applying an analysis model for a time-series variability analysis to the preprocessed time-series data; and extracting the produced data feature and generating the diagnosis model based on the extracted produced data feature.

The method may further include training the generated diagnosis model using the time series data prior to the preprocessing.

The method may further include selecting the analysis model according to a feature of the disease.

The method may further include: producing data feature information of the extracted produced data feature by conducting a second time-series variability analysis on the extracted produced data feature; and extracting the produced data feature information, wherein the generating of the diagnosis model based on the extracted produced data feature includes generating the diagnosis model based on the extracted produced data information.

The preprocessing of the time-series data may include one of: selecting a part of the time-series data; generating one value or any combination of two or more values among a sum, an average, a median, a maximum, a minimum, a variance, a standard deviation, a number of outliers, a value equal to or greater than a reference value, and a value equal to or less than the reference value of the time-series data at predetermined time points; and extracting a part or a particular value of the time-series data at predetermined time periods.

The data feature may include a trend, a cycle, seasonality, and volatility.

The analysis model may include any one or any combination of two or more of a time varying coefficient model, an autoregressive conditional heteroskedasticity (ARCH) model, a generalized ARCH (GARCH) model, a stochastic volatility model, and a model combined with an autoregressive integrated moving average (ARIMA) model.

A non-transitory computer-readable medium may store program instructions that, when executed by a processor, cause the processor to perform the method.

Other features and aspects will be apparent from the following detailed description, the drawings, and the claims.

### BRIEF DESCRIPTION OF THE DRAWINGS

FIG. 1 is a block diagram showing a configuration of a system for generating a diagnosis model, according to an embodiment.

FIG. 2 is a graph showing an example of time-series data including observed activity amount values of a particular individual acquired by an actigraphy sensor.

FIG. 3 is a graph showing an example of time-series data including observed blood glucose values of a particular individual acquired by a blood glucose measurement device.

FIG. 4 is a block diagram showing a configuration of a system for generating a diagnosis model, according to another embodiment.

FIG. 5 is a block diagram showing a configuration of a system for generating a diagnosis model, according to another embodiment.

FIG. 6 is a block diagram showing a configuration of a system for generating a diagnosis model, according to yet another embodiment.

FIG. 7 is a flowchart showing operations of a method of generating a diagnosis model, according to an embodiment.

FIG. 8 is a flowchart showing operations of a method of generating a diagnosis model, according to another embodiment.

FIG. 9 is a flowchart showing operations of a method of generating a diagnosis model, according to another embodiment.

FIG. 10 is a flowchart showing operations of a method of generating a diagnosis model, according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In general, time-series data refers to data including values which have been observed or detected in chronological order, and various time-series analysis techniques for finding regularity shown over time by analyzing time-series data are known. Time-series analysis techniques are used to analyze time-oriented data or estimate future values of time-series data.

For example, time-series analysis techniques include an autoregressive (AR) model, a moving average (MA) model, an autoregressive moving average (ARMA) model, an autoregressive integrated moving average model (ARIMA) model, seasonal ARIMA models, stochastic volatility models, an autoregressive-moving average model with exogenous inputs (ARMAX) model, and a Kalman filter. In particular, among techniques capable of analyzing the variability or volatility of time-series data, techniques employing stochastic volatility models are known. Stochastic volatility models include an autoregressive conditional heteroskedasticity (ARCH) model, a generalized ARCH (GARCH) model, a general stochastic volatility model, and so on.

In general, data acquired by monitoring a health condition of a patient for a long time is time-series data. For example, observational values of blood glucose levels of a diabetic patient, observational values of atrial fibrillation of an arrhythmia patient, and observational values of an amount of activity of an attention deficit hyperactivity disorder (ADHD) patient, a dementia patient having Alzheimer's disease, or a melancholiac may be handled as time-series data measured at certain time intervals for a period of several days to several months. Therefore, by applying various time-series analysis techniques to time-series data measured from a patient, it is possible to find temporal variability of condition of a patient. In general, according to a time-series analysis technique, it is possible to extract variability features of time-series data in various ways, and it is further possible to analyze variability hidden in changes in observational values. Therefore, by applying a time-series analysis technique to observational data which represents a disease of a patient, it is possible to find various and significant variability characteristics related to a disease.

When a diagnosis model is generated based on temporal variability of a disease, it is possible to estimate a temporal change process of a disease condition. A diagnosis model based on temporal variability of a disease has parameters based on temporal variability of a particular disease, thus making it possible not only to diagnose whether a particular individual has a disease but also to find a changed condition, such as occurrence of a disease, reoccurrence of a disease, or recovery from a disease. Furthermore, it is possible to estimate a risk of disease occurrence in the future.

In particular, according to a time-series analysis method, it is possible to capture variability or changeability features from time-series data and to model hidden variability. Therefore, it is expected that the time-series analysis method will be well applied to diseases which are difficult to diagnose based on temporary changes in observational values alone. For example, in general, temporary hyperactivity and inability to concentrate cannot automatically be diagnosed as ADHD. Rather, ADHD may be diagnosed through long-term observation and various tests of a patient. On the other hand, when a diagnosis model generated through a time-series variability analysis of previously accumulated disease group data is used, it will be possible to readily determine whether or not a patient has a disease by monitoring the daily life of the patient for a relatively short period of time.

In consideration of the aspects described above, a system and method for generating a diagnosis model, according to embodiments, provide a diagnosis model generation technique based on at least one feature extracted through a time-series variability analysis of time-series data acquired from patients suffering from a disease. One or more features extracted through a time-series variability analysis may correspond to a parameter, a function, or a model that enables a generated diagnosis model to determine a particular disease and/or determine whether a patient has recovered from a disease.

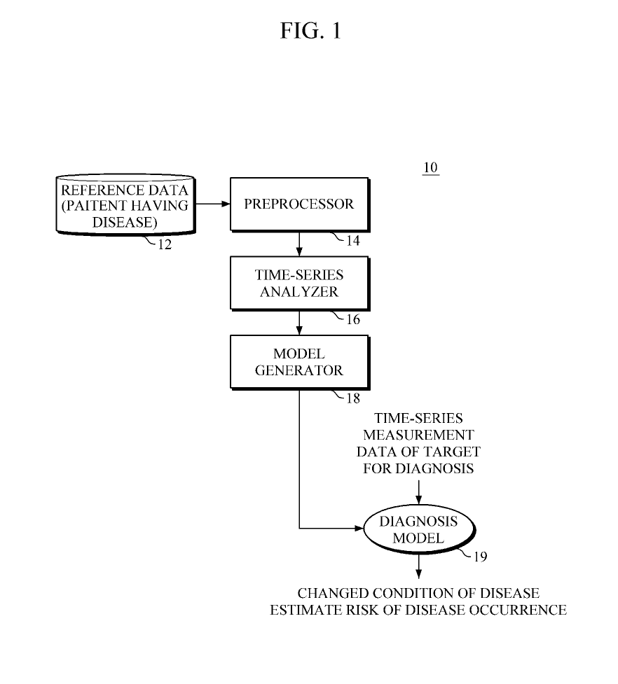

Embodiments of a system for generating a diagnosis model will be described below with reference to FIGS. 1 to 6. The systems described with reference to FIGS. 1 to 6 are merely examples. It is to be understood that it is possible to obtain other systems having various combinations of components and features within the scope of the claims.

FIG. 1 is a block diagram showing a configuration of a system 10 for generating a diagnosis model, according to an embodiment. Referring to FIG. 1, the system 10 includes a preprocessor 14, a time-series analyzer 16, and a model generator 18 for generating a diagnosis model 19 from reference data 12.

The reference data 12 is observational data obtained from a patient having a particular disease, that is, a patient suffering from the disease. The observational data may be, for example, time-series data which has been continuously measured for several days to several months. The time-series data may show repeated similar patterns or an irregular pattern which is difficult to detect by visual inspection.

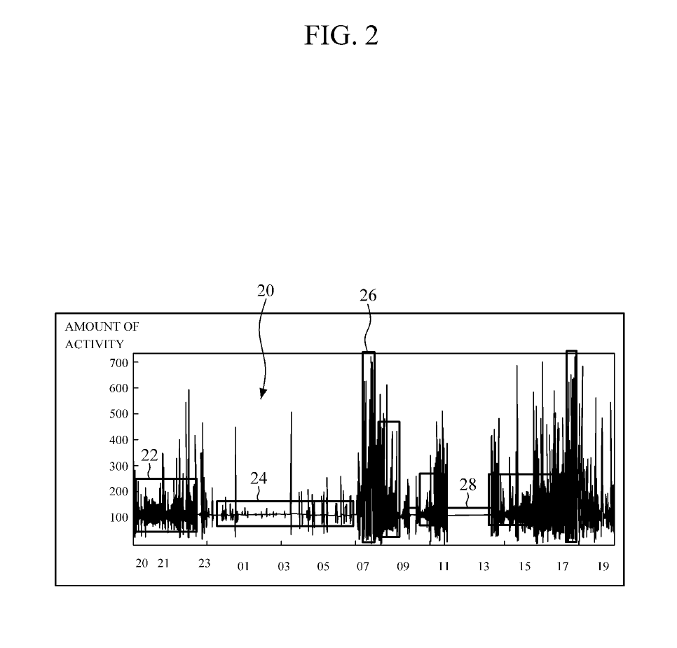

According to an example, the reference data 12 is data related to an activity amount (“activity amount data”) of a patient obtained through a motion sensor device, such as an actigraphy sensor, or a pedometer, worn on the body of the patient. An actigraphy sensor is, for example, a watch-type motion sensor device that generally has a two-axis and/or three-axis accelerometer and measures movement of a patient at certain time intervals, for example, at 60 Hz, and stores the measured movement or transmits the measured movement to an external device. A detailed example of such activity amount data is shown in FIG. 2.

Referring to FIG. 2, the graph shows data, based on a 24-hour time clock, from 20 o'clock (8 p.m.) of a day to 20 o'clock of a next day among observational values measured from a person who is a subject to observation by the actigraphy sensor. Activity amount data 20 shown in the drawing shows irregular changes in the amount of activity over time. In the drawing, the leftmost period 22 is between about 20 o'clock and about 22 o'clock and shows observed activity amount values when the person who is being observed comes home from work. The next period 24 is between about 24 o'clock and about 6 o'clock and shows activity amount values observed during sleep. The next periods 26 and 28 respectively show a case in which the person exercises (for example, jogs) at around 7 a.m., and a case in which the person stays indoors during the daytime. As the example shown in the drawing, activity amount data is time-series data showing movement of an observed person. Such activity amount data is obtained, for example, from a dementia patient, an ADHD patient, or a patient with another disorder.

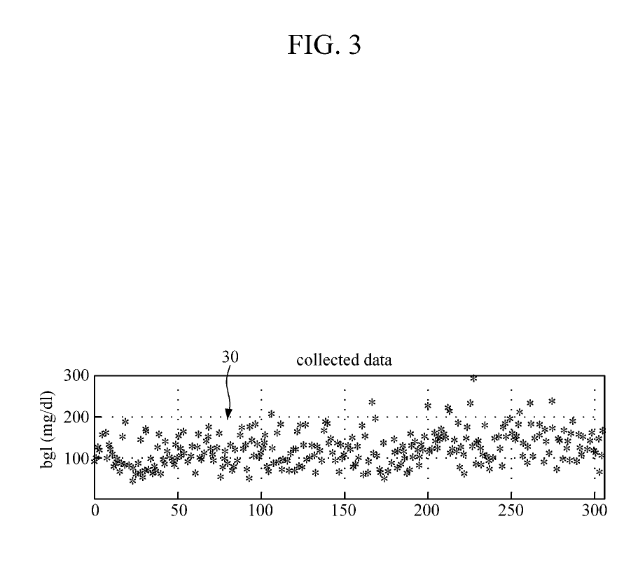

Referring back to FIG. 1, according to another example, the reference data 12 is data obtained by a diabetic patient or a guardian of the patient measuring and recording a blood glucose level of the patient at certain time intervals. The patient may measure a blood glucose level from blood taken from his or her fingertip using a blood glucose measurement device in the form of a mobile electronic device at the certain time intervals at home, without visiting a hospital. The measured blood glucose levels may be stored in the blood glucose measurement device and transmitted to an external device. Alternatively, at every measurement of a blood glucose level of the patient, the patient or the guardian may execute a word processor program or an application for blood glucose levels and then record the blood glucose level displayed on a display screen of the blood glucose measurement device by inputting the blood glucose level using a keyboard or a mouse. A detailed example of such blood glucose data is shown in FIG. 3.

Referring to FIG. 3, the graph shows an example of time-series data made up of observed blood glucose values 30 of a particular individual acquired by a blood glucose measurement device. In the graph of FIG. 3, the horizontal axis represents time, and the vertical axis represents a blood glucose value.

Referring back to FIG. 1, time-series data measured from a patient having a particular disease is used to form the reference data 12, and thus the reference data 12 may include other observational data in addition to the activity amount data of an ADHD patient and the blood glucose data of a diabetic mentioned above as examples. For example, the reference data 12 includes electrocardiogram (ECG) data of a heart failure patient and measurement data which shows a physiological condition of a patient having a stress test in various forms. However, the reference data is not limited to the examples provided herein.

According an embodiment, the preprocessor 14 is a component that preprocesses observational values of the reference data 12 measured from a patient having a particular disease. The preprocessor 14 may process observational values of the reference data 12 to improve diagnosis efficiency for a particular disease. In other words, the preprocessor 14 may extract a feature section which effectively shows a feature of a particular disease from observational values of the reference data 12.

In an example, the preprocessor 14 extracts all original observational values as a feature section by selecting all the original observational values as they are. In another example, the preprocessor 14 generates processed values, such as the sum, the average, the median, the maximum, the minimum, the variance, the standard deviation, the number of outliers, a value equal to or greater than a reference value, and/or a value equal to or less than the reference value of observational data, at every particular time point (e.g., every second, every day, or every week), thereby extracting the processed values as a feature section. In still another example, the preprocessor 14 extracts observational values of some periods or time points among consecutive unit time periods of observational values, thereby extracting the extracted observational values as representative values, that is, a feature section, of the unit time periods. As an example, observational values of daytime or nighttime in 24 hours of a day are extracted as representative values of a single day. As another example, only observational values during sleeping are extracted as representative values of a day. In yet another example, observational values are only extracted three hours after taking a medicine, as representative values of a time period up to the next time the medicine is taken. As a result, the preprocessor 14 extracts a feature section from observational values through selection, processing, and extraction, and provides values of the extracted feature section to the time-series analyzer 16.

According an embodiment, the time-series analyzer 16 is a component that analyzes the feature section values input through the preprocessor 14 by applying a time-series analysis technique to the feature section values. The feature section values input from the preprocessor 14 are in chronological order and are time-series data. The time-series analyzer 16 uses a time-series modeling technique and, particularly, may analyze time-series data using time-series variability analysis. The time-series analyzer 16 may find features of time-series data, that is, a trend, a cycle, a seasonality, a regularity, an irregularity, a variability and/or a volatility.

Analysis models for time-series variability analysis which may be used by the time-series analyzer 16 include a time varying coefficient model, an ARCH model, a GARCH model, a stochastic volatility model, and a model combined with an ARIMA model but are not limited thereto. Since such various analysis models for time-series variability analysis are well known in the corresponding technical field, a detailed description will be omitted in this specification.

As a result, data features of values of a feature section, for example, a trend, a periodicity, a seasonality, a volatility, a regularity, and/or an irregularity, are produced by the time-series analyzer 16. These data features are subsequently input to the model generator 18.

According an embodiment, the model generator 18 is a component that extracts the data features input from the time-series analyzer 16 as features to help in diagnosing a particular disease, and generates a diagnosis model based on the extracted features. In an example, the “trend” among the data features is extracted as a feature which represents a parameter indicating improvement in a health condition. In another example, the “seasonality” among the data features is extracted as a feature that represents a model showing the status of a disease. In still another example, the “irregularity” among the data features is extracted as a feature that represents a function for detecting the occurrence of a disease. When one or more features are extracted in this way, the model generator 18 generates the diagnosis model 19 for a particular disease by mapping the feature to a parameter, a function, and/or a model, for example.

After that the diagnosis model 19 is generated, the diagnosis model 19 is applied to time-series measurement data obtained from a patient that is a subject of diagnosis, thereby providing a diagnosis result, such as a changed state of a particular disease (e.g., deterioration or improvement), or an estimation of the risk of disease occurrence.

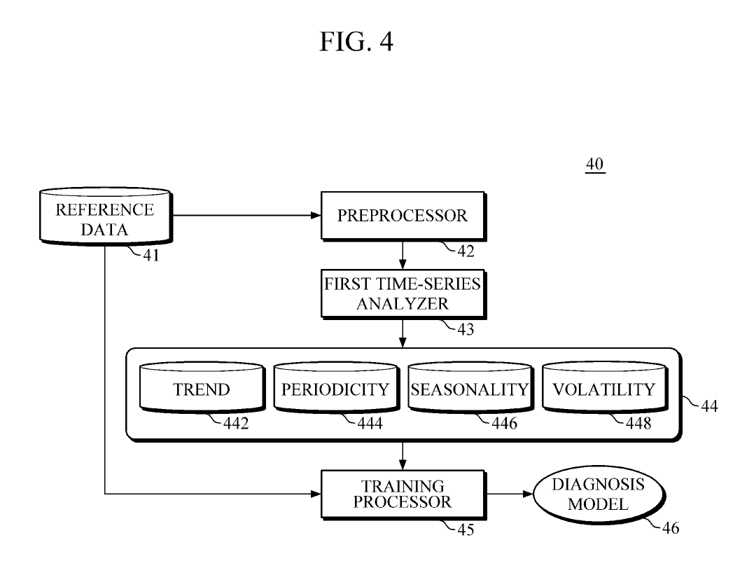

FIG. 4 is a block diagram showing a configuration of a system 40 for generating a diagnosis model, according to another embodiment. Referring to FIG. 4, the system 40 includes a preprocessor 42, a first time-series analyzer 43, a first model generator 44, and a training processor 45 configured to generate a diagnosis model 46 from reference data 41. The components other than the training processor 45 operate similarly to the components of the system 10 described above with reference to FIG. 1.

According an embodiment, the reference data 41 is similar to the reference data 12 of FIG. 1 and includes observational values of patients having a particular disease in chronological order. The preprocessor 42 is similar to the preprocessor 14 of FIG. 1. That is, the preprocessor 42 extracts a feature section which shows a feature of the particular disease best from the observational values of the reference data 41 and provides the extracted feature section to the first time-series analyzer 43. The first time-series analyzer 43 is similar to the time-series analyzer 16 of FIG. 1. More specifically, the first time-series analyzer 43 analyzes values of the feature section using a time-series model reflecting time-series variability, thereby producing various data features, such as a trend, a periodicity, a seasonality, a regularity, an irregularity, and/or a volatility. These data features are provided to the first model generator 44. The first model generator 44 is similar to the model generator 18 of FIG. 1, and thus may extract a trend 442, a periodicity 444, a seasonality 446, and a volatility 448 as features from the data features. The extracted features are mapped to parameters, functions, models, etc. constituting the diagnosis model 46 so that the diagnosis model 46 for diagnosing the particular disease is determined. FIG. 4 shows that the first model generator 44 extracts the trend 442, the periodicity 444, the seasonality 446, and the volatility 448 as features. However, this is merely an example, and embodiments of the disclosure are not limited to the embodiments specifically described herein.

According to an embodiment, the training processor 45 is a component that adjusts the features extracted by the first model generator 44 by verifying the features using the original reference data 41 or by having the features learn the original reference data 41. Since the features extracted by the first model generator 44 are based on results of the time-series analysis of the values preprocessed by the preprocessor 42, it is possible to generate the diagnosis model 46 to be more reliable by verifying the features using the observational values directly measured from the original patients having the particular disease.

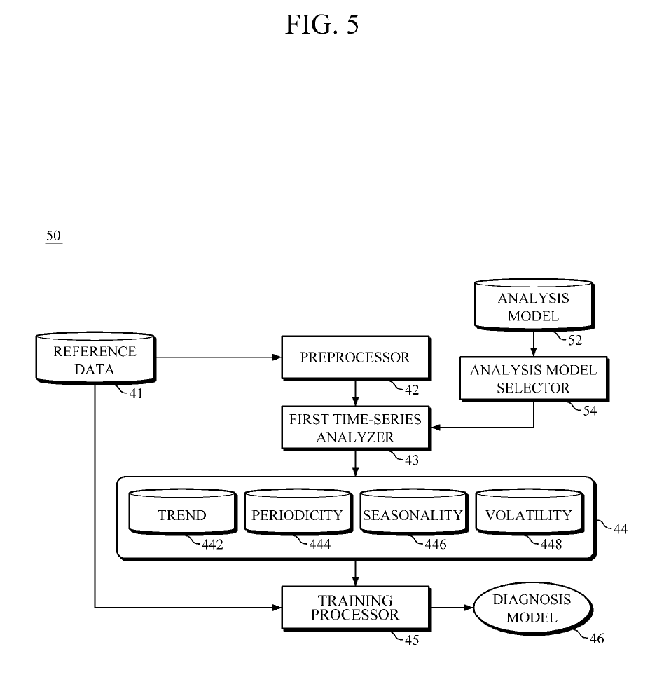

FIG. 5 is a block diagram showing a configuration of a system 50 for generating a diagnosis model, according to another embodiment.

Referring to FIG. 5, like the system 40 which has been described above with reference to FIG. 4, the system 50 includes the preprocessor 42, the first time-series analyzer 43, the first model generator 44, and the training processor 45 for generating the diagnosis model 46 from the reference data 41. Compared to the system 40 of FIG. 4, the system 50 of FIG. 5 further includes an analysis model selector 54 which enables selection of an analysis model of the first time-series analyzer 43, and an analysis model storage 52.

While the first time-series analyzer 43 performs time-series variability analysis processes in the embodiments of FIGS. 1 and 4 using predefined analysis models, the first time-series analyzer 43 performs time-series variability analysis processes in the embodiment of FIG. 5 using analysis models selected by the analysis model selector 54. The analysis model storage 52 stores a variety of known analysis models, such as an ARCH model, a model combined with an ARIMA model, a stochastic volatility model, and/or a stochastic volatility model including sudden jump components. The analysis model selector 54 selects an analysis model, from among various analysis models stored in the analysis model storage 52, that is suited to the analysis of a particular disease corresponding to data stored in the reference data 41. The analysis model selector 54 operates to select a particular analysis model using, for example, the Bayesian information criterion (BIC), the Akaike information criterion (AIC). FIG. 5 shows that the model generator 44 extracts a trend 442, a periodicity 444, a seasonality 446, and a volatility 448 as features. However, this merely is an example, and embodiments of the disclosure are not limited to those specifically described herein.

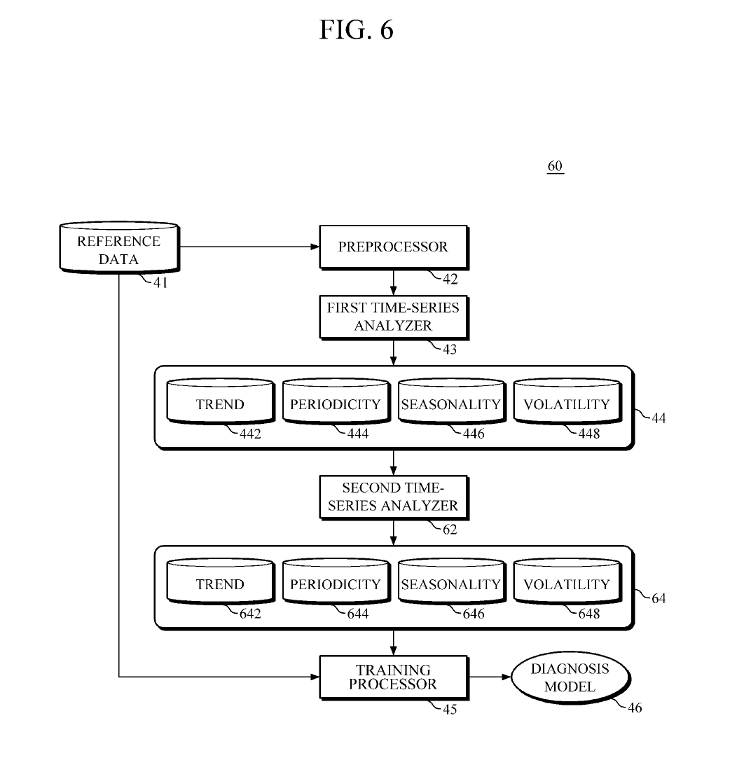

FIG. 6 is a block diagram showing a configuration of a system 60 for generating a diagnosis model, according to another embodiment. Referring to FIG. 6, like the system 40 which has been described above with reference to FIG. 4, the system 60 includes the preprocessor 42, the first time-series analyzer 43, a second time-series analyzer 62, the first model generator 44, a second model generator 64, and the training processor 45 for generating the diagnosis model 46 from the reference data 41. The system 60 of FIG. 6 differs from the system 40 of FIG. 4 in that time-series analysis and feature extraction are performed two times.

The first time-series analyzer 43 analyzes values of a feature section input from the preprocessor 42 using a time-series variability analysis model, thereby producing data features, such as a trend 442, a periodicity 444, a seasonality 446, a regularity, an irregularity, and a volatility 448. Then, the first model generator 44 extracts features from among the data features produced by the first time-series analyzer 43. The second time-series analyzer 62 further analyzes each of the features of the first model generator 44 using a time-series variability analysis model. The second time-series analyzer 62 conducts separate time-series variability analyses of the trend 442, the periodicity 444, the seasonality 446, and the volatility 448 among the features of the first model generator 44, thereby producing data feature information including each of a trend 642, a periodicity 644, a seasonality 646, and a volatility 648. Then, the second model generator 64 extracts the trend 642, the periodicity 644, the seasonality 646, and the volatility 648 as other features. Accordingly, the system 60 generates the diagnosis model 46 in consideration of features extracted by one or both of the first model generator 44 and the second model generator 64. The drawing shows that the model generators 44 and 64 extract the trends 442 and 642, the periodicity 444 and 644, the seasonality 446 and 646, and the volatility 448 and 648 as features. However, this is merely an example, and embodiments of the disclosure are not limited to this example.

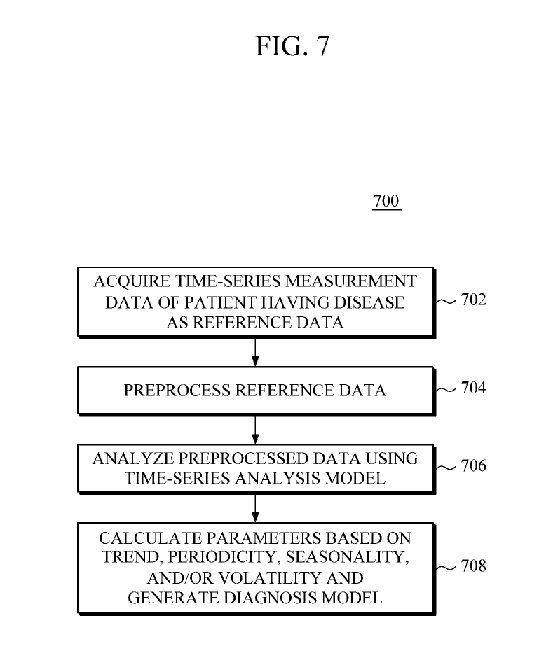

Embodiments of a method of generating a diagnosis model will be described below with reference to FIGS. 7 to 10. The described methods are merely examples, and it is to be understood that it is possible to obtain other methods having various combinations of operations and features.

FIG. 7 is a flowchart showing operations of a method 700 of generating a diagnosis model, according to an embodiment. Referring to FIG. 7, the method 700 includes a reference data acquisition operation 702, a preprocessing operation 704, a time-series analysis operation 706, and a diagnosis model generation operation 708.

In the reference data acquisition operation 702, time-series measurement data observed from a patient having a particular disease, that is, a patient suffering from the disease, is acquired through sensor-based monitoring. In an example, the time-series measurement data is acquired by receiving values observed in real time through a communication network. In another example, the time-series measurement data is acquired by a computing device reading a storage device, such as a memory, or a hard disk, in which the time-series measurement data is stored. In another example, the time-series measurement data is manually input by a user and acquired. Data in chronological order is suitable as observational values constituting the reference data, and observation points in time corresponding to the respective observational values do not need to be regular.

Then, in the preprocessing operation 704, the reference data is preprocessed as time-series data which shows a feature of the particular disease best and is suited to time-series analysis. In the preprocessing operation 704, according to an example, only observational values of a time period which shows a feature of the particular disease best are selected from among the observational values of the reference data. Alternatively, in the preprocessing operation 704, only observational values of certain points in time or a certain time period are extracted from the observational values of the reference data. Alternatively, in the preprocessing operation 704, processed values, such as the average, the deviation, the sum, the variance, the maximum, the median, the minimum, and/or a value equal to or less than a reference value of observational values of a particular time period, are generated from the observational values of the reference data.

In the time-series analysis operation 706, preprocessed values of the preceding operation 704 are analyzed according to a time-series variability analysis technique, and information representing data features, such as a trend, a periodicity, a seasonality, a regularity, an irregularity, and/or a volatility, are generated according to an analysis model.

After that, in the diagnosis model generation operation 708, features for diagnosing the particular disease are extracted from the data feature information generated by the time-series analysis, and a diagnosis model including these features as parameters is generated.

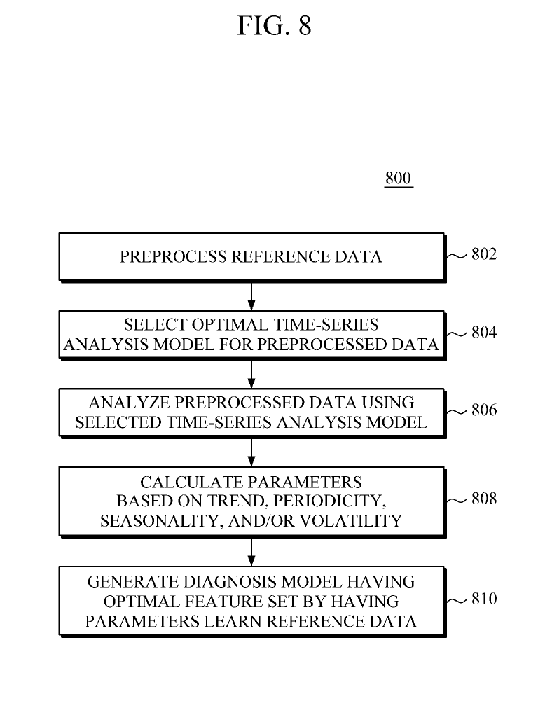

FIG. 8 is a flowchart showing operations of a method 800 of generating a diagnosis model, according to another embodiment. Referring to FIG. 8, the method 800 includes a reference data preprocessing operation 802, an analysis model selection operation 804, a time-series analysis operation 806, a diagnosis model generation operation 808, and a diagnosis model training operation 810.

In the reference data preprocessing operation 802, reference data is preprocessed. The reference data is time-series measurement data observed from a patient having a particular disease, that is, a patient suffering from the disease, through sensor-based monitoring. Data in chronological order is used to form observational values constituting the reference data, and observation points in time corresponding to the respective observational values are not necessarily regular. In the preprocessing operation 802, the reference data is preprocessed as time-series data which is suited to a time-series analysis, while showing a feature of the particular disease best.

In the analysis model selection operation 804 after (or simultaneously with) the preprocessing operation 802, an analysis model for conducting a time-series analysis of the preprocessed values is selected. For example, in the case of a disease showing a drastic change, an analysis model for analyzing a feature with drastic variability is selected. On the other hand, in the case of a disease causing a gradual change over a long time period, an analysis model for analyzing a feature with slow variability over a long time period may be selected.

Then, in the time-series analysis operation 806, a time-series variability analysis is conducted on the preprocessed values resulting from the reference data preprocessing operation 802 according to the selected analysis model of the analysis model selection operation 804, and information representing data features, such as a trend, a periodicity, a seasonality, a regularity, an irregularity, and/or a volatility, is generated. Then, features related to the trend, the periodicity, the seasonality, and/or the volatility are extracted, and parameters are calculated based on the extracted features, so that a diagnosis model having the calculated parameters is generated in operation 808.

Subsequently, in operation 810, the parameters of the generated diagnosis model learn the reference data used in the preprocessing operation 802 so that a diagnosis model having an optimal feature set is generated.

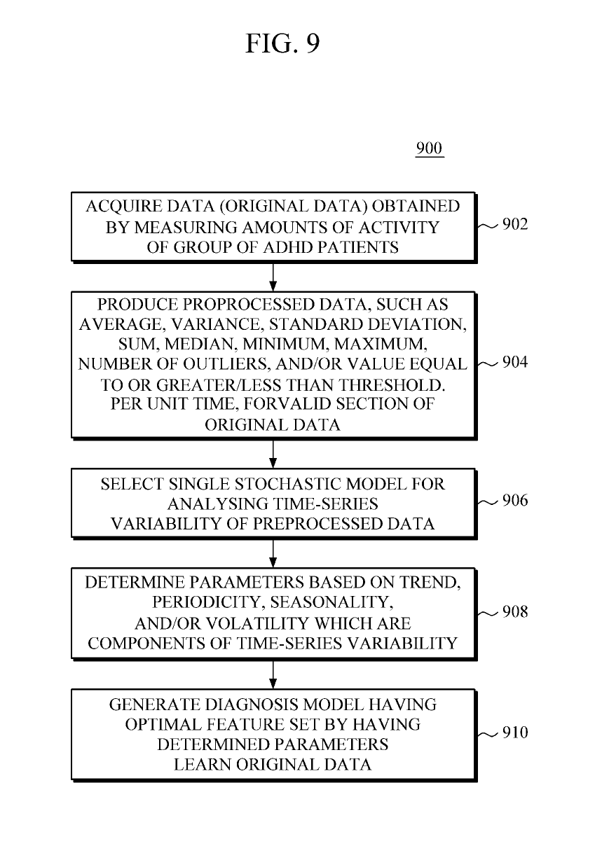

FIG. 9 is a flowchart showing operations of a method 900 of generating a diagnosis model, according to another embodiment. Referring to FIG. 9, the method 900 includes a reference data acquisition operation 902, a preprocessing operation 904, an analysis model selection operation 906, a diagnosis model generation operation 908, and a diagnosis model training operation 910.

In the reference data acquisition operation 902, data (original data) obtained by measuring the amounts of activity of a group of AHDH patients is acquired. The amounts of activity may be collected by actigraphy devices worn on wrists of patients who have been diagnosed with ADHD. In general, actigraphy devices perform collecting of activity amount data sensed at certain time intervals, for example, 30 Hz or 60 Hz. Thus, activity amount data collected by actigraphy devices is time-series data.

In the preprocessing operation 904, the acquired activity amount data, that is, the original data, is preprocessed. The preprocessed data, which has been processed as an average, a variance, a standard deviation, a sum, a median, a minimum, a maximum, a number of outliers, and/or a value equal to or greater/less than a threshold, per unit time, is produced for a valid section of the original data.

The analysis model selection operation 906 is performed before, after, or simultaneously with the preprocessing operation 904. In this example, a stochastic model specialized to analyze a feature of drastic variability is selected as an analysis model for conducting a time-series volatility or variability analysis.

Then, in the diagnosis model generation operation 908, a time-series variability analysis is conducted on the preprocessed values of the preprocessing operation 904 according to the selected analysis model of the analysis model selection operation 906, and information representing data features, such as a trend, a periodicity, a seasonality, a regularity, an irregularity, and/or a volatility, is generated. Then, in operation 908, features related to the trend, the periodicity, the seasonality, and/or the volatility are extracted, and parameters are calculated based on the extracted features, so that a diagnosis model having the calculated parameters is generated. Subsequently, in operation 910, the parameters of the generated diagnosis model learn the original data used in the preprocessing operation 904 so that a diagnosis model having an optimal feature set is generated.

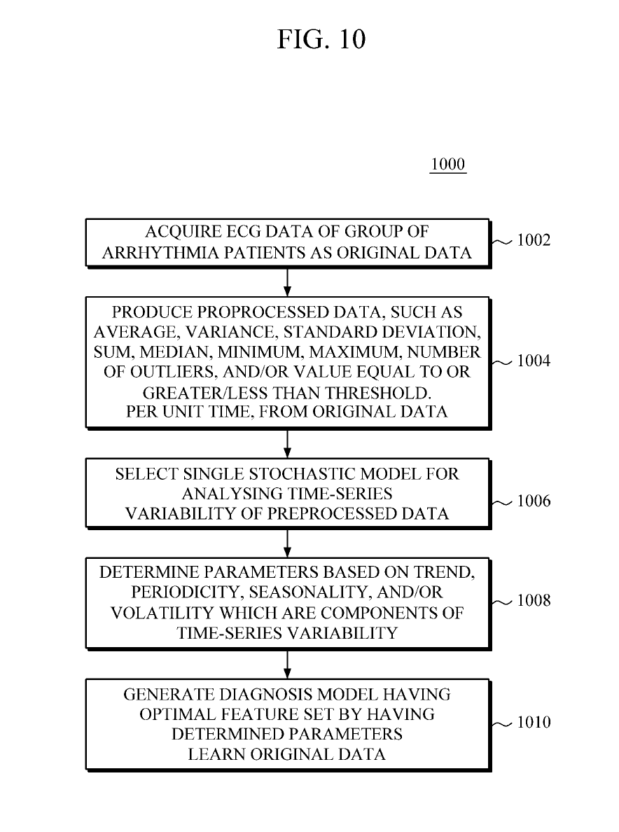

FIG. 10 is a flowchart showing operations of a method 1000 of generating a diagnosis model, according to another embodiment. Referring to FIG. 10, the method 1000 includes a reference data acquisition operation 1002, a preprocessing operation 1004, an analysis model selection operation 1006, a diagnosis model generation operation 1008, and a diagnosis model training operation 1010.

In the reference data acquisition operation 1002, ECG data (original data) of a group of arrhythmia patients is acquired. The ECG data may be collected by ECG sensors attached to patients who have been diagnosed with arrhythmia. In general, ECG sensors perform collecting ECG data sensed at certain time intervals, for example, 30 Hz or 60 Hz, and thus ECG data collected by ECG sensors is time-series data.

In the preprocessing operation 1004, the acquired ECG data, that is, the original data, is preprocessed. The preprocessed data, which has been processed as an average, a variance, a standard deviation, a sum, a median, a minimum, a maximum, a number of outliers, and/or a value equal to or greater/less than a threshold, per unit time, is produced for a valid section of the original data.

The analysis model selection operation 1006 is performed before, after, or simultaneously with the preprocessing operation 1004. In this example, a stochastic model specialized to analyze a feature of slow variability over a long time period is selected as an analysis model for conducting a time-series volatility or variability analysis of ECG data. Selection of the analysis model may be automatically made according to a disease or may be made by an input of a user when selection is requested from the user.

Then, in the diagnosis model generation operation 1008, a time-series variability or volatility analysis is conducted on the values preprocessed in the preprocessing operation 1004 according to the selected analysis model of the analysis model selection operation 1006, and information representing data features, such as a trend, a periodicity, a seasonality, a regularity, an irregularity, and/or a volatility is generated. Then, in operation 1008, features related to the trend, the periodicity, the seasonality, and/or the volatility are extracted, and parameters are calculated based on the extracted features so that a diagnosis model having the calculated parameters is generated. Subsequently, in operation 101, the parameters of the generated diagnosis model learn the original data used in the preprocessing operation 1004, so that a diagnosis model having an optimal feature set is generated.

According to the disclosed examples, a diagnosis model is generated based on a time-series variability analysis of observational data acquired from a patient, and thus it is possible not only to determine whether the patient has a disease, but also to find a changed condition, such as occurrence of a disease, reoccurrence of a disease, and recovery from a disease. Furthermore, it is possible to provide a diagnosis model that enables estimation of a risk of disease occurrence in the future.

The preprocessor 14, the time-series analyzer 16 and the model generator 18 in FIG. 1, the preprocessor 42, the time-series analyzer 43, the first model generator 44 and the training processor 45 in FIGS. 4 to 6, the analysis model selector 54 in FIG. 5, and the second time-series analyzer 62 and the second model generator 64 in FIG. 6 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. FIGS. 7 to 10 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A system to generate a diagnosis model, the system comprising:
a preprocessor configured to preprocess time-series data observed from a patient having a disease;
a time-series analyzer configured to produce a data feature by applying an analysis model for a time-series variability analysis to the preprocessed time-series data; and
a model generator configured to extract the produced data feature and to generate the diagnosis model based on the extracted produced data feature.

2. The system of claim 1, further comprising:
a training processor configured to train the diagnosis model generated by the model generator using the time-series data before prior to the time-series data being preprocessed by the preprocessor.

3. The system of claim 1, further comprising an analysis model selector configured to select the analysis model according to a feature of the disease.

4. The system of claim 1, wherein:
the time-series analyzer comprises
a first time-series analyzer configured to produce the data feature by applying the analysis model for the time-series variability analysis to the preprocessed time-series data, and
a second time-series analyzer configured to produce data feature information of the extracted produced data feature by conducting a time-series variability analysis on the extracted produced data feature; and
the model generator is further configured to generate the diagnosis model based on the data feature information.

5. The system of claim 4, wherein the model generator comprises:
a first model generator configured to extract the data feature produced by the first time-series analyzer; and
a second model generator configured to extract the data feature information produced by the second time-series analyzer.

6. The system of claim 1, wherein the preprocessor is further configured to:
select a part of the time-series data;
generate any one value or any combination of two or more values among a sum, an average, a median, a maximum, a minimum, a variance, a standard deviation, a number of outliers, a value equal to or greater than a reference value, and a value equal to or less than the reference value of the time-series data at predetermined time points; or
extract a part or a particular value of the time-series data at predetermined time periods.

7. The system of claim 1, wherein the data feature comprises a trend, a cycle, seasonality, and volatility.

8. The system of claim 1, wherein the analysis model comprises any one or any combination of two or more of a time varying coefficient model, an autoregressive conditional heteroskedasticity (ARCH) model, a generalized ARCH (GARCH) model, a stochastic volatility model, and a model combined with an autoregressive integrated moving average (ARIMA) model.

9. The system of claim 1, wherein the time-series data comprises data obtained from an actigraphy sensor worn by the patient.

10. A method to generate a diagnosis model, the method comprising:
preprocessing time-series data observed from a patient having a disease;
producing a data feature by applying an analysis model for a time-series variability analysis to the preprocessed time-series data; and
extracting the produced data feature and generating the diagnosis model based on the extracted produced data feature.

11. The method of claim 10, further comprising training the generated diagnosis model using the time series data prior to the preprocessing.

12. The method of claim 11, further comprising:
selecting the analysis model according to a feature of the disease.

13. The method of claim 10, further comprising:
producing data feature information of the extracted produced data feature by conducting a second time-series variability analysis on the extracted produced data feature; and
extracting the produced data feature information,
wherein the generating of the diagnosis model based on the extracted produced data feature comprises generating the diagnosis model based on the extracted produced data information.

14. The method of claim 10, wherein the preprocessing of the time-series data comprises one of:
selecting a part of the time-series data;
generating one value or any combination of two or more values among a sum, an average, a median, a maximum, a minimum, a variance, a standard deviation, a number of outliers, a value equal to or greater than a reference value, and a value equal to or less than the reference value of the time-series data at predetermined time points; and
extracting a part or a particular value of the time-series data at predetermined time periods.

15. The method of claim 10, wherein the data feature comprises a trend, a cycle, seasonality, and volatility.

16. The method of claim 10, wherein the analysis model comprises any one or any combination of two or more of a time varying coefficient model, an autoregressive conditional heteroskedasticity (ARCH) model, a generalized ARCH (GARCH) model, a stochastic volatility model, and a model combined with an autoregressive integrated moving average (ARIMA) model.

17. A non-transitory computer-readable medium storing program instructions that, when executed by a processor, cause the processor to perform the method of claim 10.
